(19) United States
(12) Patent Application Publication
(10) Pub. No.: US 2008/0215849 A1
(43) Pub. Date: Sep. 4, 2008

(54) HASH TABLE OPERATIONS WITH IMPROVED CACHE UTILIZATION

(76) Inventor: Thomas Scott, Newton, MA (US)

Correspondence Address: GOODWIN PROCTER LLP;PATENT ADMINISTRATOR, EXCHANGE PLACE, BOSTON, MA, 02109-2881, US

(21) Appl. No.: 12/038,523

(22) Filed: Feb. 27, 2008

Related U.S. Application Data
(60) Provisional application No. 60/904,112, filed on Feb. 27, 2007.

(51) Int. Cl. G06F 12/00

(52) U.S. Cl. 711/216; 711/E12.018

(57) ABSTRACT

Method and apparatus for building large memory-resident hash tables on general purpose processors. The hash table is broken into bands that are small enough to fit within the processor cache. A log is associated with each band and updates to the hash table are written to the appropriate memory-resident log rather than being directly applied to the hash table. When a log is sufficiently full, updates from the log are applied to the hash table insuring good cache reuse by virtue of false sharing of cache lines. Despite the increased overhead in writing and reading the logs, overall performance is improved due to improved cache line reuse.

### CROSS-REFERENCE TO RELATED APPLICATIONS

This application claims the benefit of U.S. Provisional Patent Application No. 60/904,112, filed Feb. 27, 2007, the contents of which are incorporated herein by reference as if set forth in their entirety.

### FIELD OF THE INVENTION

The present invention relates to methods and apparatus for organizing data and, more particularly, to methods and apparatus for improving the performance of hash table updates.

### BACKGROUND OF THE INVENTION

Hash tables are data structures that are used in data processing applications where high performance data retrieval is critical. Data retrieval in a hash table generally consists of finding a value that is uniquely associated with a key. The data structures for storing these key-value pairs can take many forms, including trees and linear lists. There are also many functions suited to associating a value with a key. The defining characteristic of hash table lookup is that for the majority of accesses, a key's value is located in a linear table at an address that is determined directly by applying a function, i.e., the hash function, to the key. Because the location for storing the value is known from the key (except in those cases where there is a hash function collision), a hash table lookup can be performed on average in constant time.

Hash tables are typically built by a sequence of hash table update operations. For each key-value pair to be added into the hash table, the value is inserted into the hash table at the location determined by applying the hash function to the key. If different keys map to the same location, a hash function collision will occur. A variety of techniques are available to deal with hash function collisions, but none significantly change the basic result that adding a key-value pair to a table can on average be done in constant time.

Hash tables are used in a great variety of applications. In many applications, the hash table is populated by updates that are interspersed with lookup operations. For such applications, the prior art typically provides adequate performance.

But for many other applications, the hash table must be built or substantially updated before use and the performance of building the hash table can be critical. An example of such an application is dictionary-based data compression, where each n-byte substring of dictionary data is mapped to its location in a hash table. Once the hash table is built, it can be used to identify substrings that are shared with the dictionary. Compression of the string can be achieved by transmitting or storing the location of the substrings in the dictionary rather than the substring itself. Since the hash table can be larger than the dictionary and many dictionaries can be used by the system, it is reasonable to build the hash tables needed prior to use. This is one exemplary application that would benefit from improved performance in building hash tables.

For the highest performance applications, hash tables are kept in memory. In these applications, hash table updates, though performed in constant time, show poor locality of reference and will not generally benefit from advances in processor data caching that have been responsible for much of the performance gains realized by general purpose data processors. Consequently, updates of hash tables that do not fit in cache memory will run at system memory speeds rather than at the much higher speeds of processor caches.

While the prior art addresses most aspects of hash table design, including hash function choice and techniques for addressing hash collisions, it is not known to address the poor processor cache utilization that can occur when making substantial updates to large memory-based hash tables. Accordingly, there is a need for hash table update techniques with improved processor cache utilization.

### SUMMARY OF THE INVENTION

Embodiments of the present invention provide methods for performing substantial updates to memory-resident hash tables that increase locality and consequently processor cache utilization when the hash table exceeds the size of the processor cache. Improving cache utilization reduces the time needed to build the hash table and the bandwidth needed by the memory subsystem. Reducing memory bandwidth reduces the system cost to achieve a specific level of performance and, on shared memory multiprocessor systems, reduces memory contention that would degrade performance.

A hash table is typically built or substantially updated from a sequence of key-value pairs applied to a linear hash table. Except for the differences in the initial state of the hash table, the operations for building the hash table for the first time or for making substantial updates to an existing hash table are identical. Embodiments of the present invention define control structures and algorithms that efficiently reorder the application of this sequence of key-value pairs for maximum performance.

In one embodiment, the memory-resident linear hash table is broken into bands of address space, each band being small enough that updates to a band can fit entirely within a processor cache memory. Associated with each band is a memory-resident log of hash table updates to be applied. Each hash table update consists of a key-value pair, where f(key) is the hash function that returns either the address or index into the hash table where the value associated with key is to be written. Instead of applying the hash updates directly to the hash table, the updates are recorded into the logs.

Each log has a predefined length, sufficiently long that when the updates that are contained within the log are applied to a band of the hash table, there is reuse of cache lines. The values of f(key) do not need to repeat for there to be cache line reuse. In a phenomenon known as false sharing, adjacent memory locations can reside in the same cache line so that the update of a cache line can benefit from a cache line miss from a prior unrelated hash table update if the updates are to the same cache line. For a sufficiently long log, the cost to apply the updates will be a cache line miss for each cache line in the band, but this cost will be amortized by the hits that will follow due to false sharing.

A typical embodiment of the invention may consist of 8-byte key-value pairs, an L2 cache size of 1-MByte, and a cache line size of 64-bytes used for hash tables that are larger than the L2 cache size. By choosing a band size of approximately half the L2 cache size, i.e., 512-kbytes, playback of the updates within a log will be mostly contained in the L2 cache while leaving approximately half of the L2 cache available for other purposes. The log should be sufficiently long to realize a performance advantage during the playback of the updates to a band. If the number of entries in the log at the time of log playback is N and the space occupied by the N updates in the hash table is much smaller than the total number of key-value pairs that can be stored in a band, then cache line sharing among the updates is unlikely, playback will incur approximately N cache misses and the cache miss rate will be nearly 100%. But, in this example, when building a hash table approaching 100% load factor, each band will consist of approximately 512-kbytes /8-bytes=65536 distinct key-value pairs. By virtue of banding, the number of cache misses is limited to approximately 512-kbytes /64-bytes=8192 misses. By choosing a log long enough to accommodate 65536 updates, the cache miss rate for playback can be reduced to 8192/65536, i.e., 12.5% by virtue of the invention.

The updates contained in each log are applied as each log becomes full and when the input sequence of key-value pairs is exhausted. Updates from a full log will receive the full benefit of the improved cache utilization. Updates from partially filled logs will receive lesser benefits.

Embodiments of the present invention exploit the fact that general purpose processors are more efficient at processing streaming data than randomly accessing memory. Despite the increased overhead in writing and reading the logs, the overall performance can be higher simply due to improved cache utilization when applying the updates to a band of memory that is small enough to reside in cache.

In one embodiment of the invention, the processor will have good hardware prefetch capabilities and instructions for reading and writing memory without persistent modifications to the cache. Good hardware prefetch allows high read performance from a log.

In another embodiment of the invention, writes to the log are aggregated in a staging buffer that is at least the size of a processor cache line. The staging buffer, when full, is written to the tail of the log using a write instruction that bypasses the processor cache (i.e. a non-temporal store instruction). Similarly, reads from the log are by instructions that preferably bypass the processor cache. Bypassing the processor cache for I/O to the logs avoids diluting the processor cache with data that is known not to have high reuse.

In a first aspect, embodiments of the present invention provide an apparatus for updating a hash table. The apparatus includes a processor, a fast memory, and a system memory. The system memory includes a hash table broken into bands, each band smaller in size than the size of the fast memory, and a plurality of logs each associated with a hash table band and comprising updates to the hash table. The processor is configured to apply updates to the hash table as each log becomes sufficiently full.

The fast memory may be a processor cache memory. Each update to the hash table may be, e.g., a key-value pair. In one embodiment, the processor is configured to place each update in a log selected in part based on the value resulting from the application of a hash function to the key k.

In another aspect, embodiments of the present invention provide a method of updating a hash table, where each update includes a key-value pair (k, v). The method includes initializing each of a plurality of logs to an empty state, selecting one of the plurality of logs based on the value f(k) resulting from the application of a hash function f to the key k in an update, appending the update to the log, and playing back the log if the log has become sufficiently full.

In one embodiment, play back of a log comprises reading each update from the log; modifying, for each read update, the hast table at the location f(k) resulting from the application of a hash function f to the key k in an update; and setting the log to the empty state once all updates have been read. In another embodiment, the method further includes playing back all of the logs. In still another embodiment, each update is read from the log in the order in which it had been appended to the log.

In yet another embodiment, selecting one of the plurality of logs includes dividing a hash table into equally sized regions of the range of f(k), each region being sufficiently small so that modifications to the region can be performed solely in a fast memory and mapping each value of f(k) to an integer than can be used to select a log from the plurality of logs. Mapping may comprise dividing f(k) by an appropriate constant or performing a bit shift by an appropriate constant.

In another embodiment, appending the update to the log comprises appending the update to a staging buffer stored in a fast memory and being a multiple of a processor cache line in size and writing the staging buffer to the log when the staging buffer is sufficiently full. Writing of the staging buffer may be performed using a store instruction that bypasses or otherwise limits the persistent modification of the fast memory.

In still another embodiment, reading each update from the log includes reading a plurality of updates from the log into a register file or a buffer in cached memory, the length of the read being a multiple of the processor cache line size. The reading of the plurality of updates may be performed using a load instruction that bypasses or otherwise limits the persistent modification of the fast memory.

### BRIEF DESCRIPTION OF THE DRAWINGS

The foregoing and other objects, features, and advantages of the present invention, as well as the invention itself, will be more fully understood when read together with the accompanying drawings, in which:

FIG. 1 is a block diagram of a typical computing system suited for use with embodiments of the present invention;

FIG. 2 is a block diagram showing the structure of a linear hash table;

FIG. 3 is a block diagram showing the composition of a log in accord with the present invention;

FIG. 4 is a block diagram showing the composition of a block within the log of FIG. 3;

FIG. 5 is a flowchart of one method for building or substantially updating a hash table in accord with the present invention;

FIG. 6 is a flowchart of one method for appending a (k,v) pair to a log in accord with the present invention;

FIG. 7 is a flowchart one method for applying the (k,v) pairs of a log to the hash table; and

FIG. 8 is a diagram of one embodiment of the present invention utilizing differential data compression to reduce the bandwidth requirements for a document transferred over a wide area network (WAN).

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

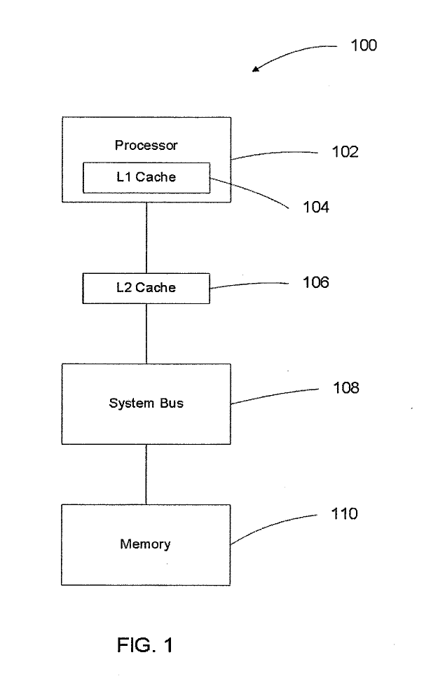

FIG. 1 shows one example of a computing system 100 suited for use with embodiments of the present invention. A processor 102 executes the instructions of a computer program. The effect of the computer program is to manipulate a hash table stored in the memory 110. A system bus 108 provides the physical means by which data is transferred between the processor 102 and the memory 110.

To improve the performance of the computing system 100, an L1 cache 104 and L2 cache 106 are typically placed in the data path. These caches 104, 106 improve performance by providing a limited amount of higher performance memory to buffer access to the memory 110. The L1 cache 104 is usually integral to the construction of the processor 102 and consequently has high performance but is constrained to a small size. The L2 cache 106 is usually external to the packaging of the processor 102 and provides buffering that is intermediate in performance and capacity between that of the L1 cache 104 and memory 110.

Another manner in which these caches 104, 106 improve performance is by increasing the size by which memory is manipulated. Instructions executed by the processor 102 typically manipulate 8-bit to 64-bit quantities of data. The caches 104, 106, on the other hand, are typically organized into 64-byte or larger cache lines that are read from and written to memory 110 through the system bus 108. The larger size of the transaction improves the efficiency of I/O to memory.

The presence of these caches 104, 106 is typically transparent to the programs that are executed on the processor 102. The memory access patterns determine the effectiveness of each cache and the degree of performance benefit. If the program accesses data that can fit entirely within the L1 cache 104, maximum performance will be achieved. If the program accesses data that can not fit in either the L1 cache 104 or the L2 cache 106, then performance will be slowest. If the program accesses data that cannot fit entirely within the L1 cache 104 but can fit in the L2 cache 106, then some intermediate level of performance will be achieved.

The number of processor caches is not material to embodiments of the present invention. All that matters is that there exists at least one higher-speed memory, such as a processor cache, that is used to improve the performance of memory accesses and that this higher-speed memory, by virtue of its size being smaller than the hash table being updated, is ineffective in boosting the performance of hash table updates. When there are multiple higher-speed memories, e.g., multiple caches, there is generally a choice as to which higher-speed memory to use with embodiments of the present invention. Performance gains will differ based on the choice of memory, and the best memory for use can be determined through experimentation.

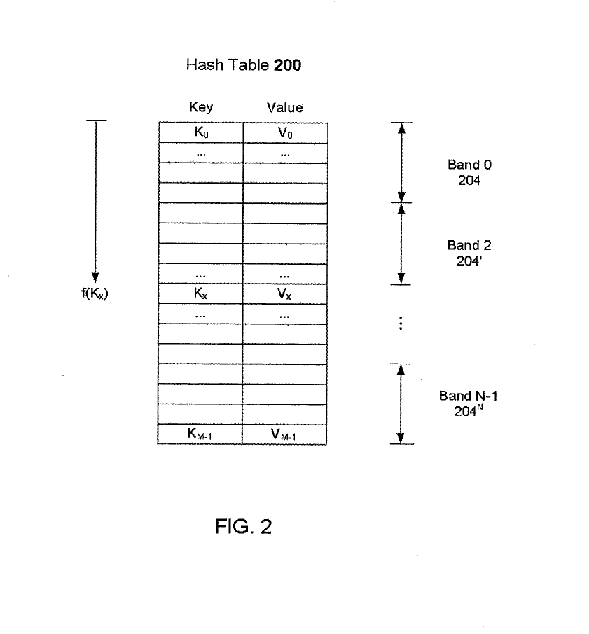

FIG. 2 shows the structure of a typical hash table 200 and one method of assigning a band to each intended hash table update. In one embodiment of the invention, the hash table consists of key-value pairs 202 that are stored at memory addresses that are determined by a hash function applied to each key. For the purposes of classifying each hash table update, the entries in the hash table are partitioned into address bands 204 of equal width, each band 204 consisting of a consecutive range of table addresses. A key-value pair that is to be updated is assigned to the band 204 that encompasses the address where that key-value pair will be stored.

In one embodiment of the invention, mechanisms that resolve hash collisions do not affect the assignment of an update to a band. A hash collision occurs when the address calculated to store a key-value pair is already occupied by a pair with a different key. Various methods are used to resolve conflicts, such as storing the key-value pair in a nearby free slot or using a secondary hash function to determine a new address. These methods may be used without affecting the assignment of an update to a band, which is itself based on the address (or equivalently, a table index) that the key-value pair would occupy in the absence of a collision.

The width of the bands 204 is an important parameter to the overall performance of embodiments of the invention. The width of the band 204 approximately corresponds to the amount of processor cache needed to apply the hash table updates of a particular band of the hash table. The width of the band 204 must be smaller than the size of the processor cache in order to improve performance. One guideline is to select a width that is 50-80% of the processor cache so that maximum benefit is achieved while still reserving some processor cache capacity for the execution of other program code.

For each band 204 of the hash table 200, a log is maintained in memory. The purpose of each log is to store the intended hash table updates for its corresponding band 204. The updates are recorded in the logs and then played back as needed.

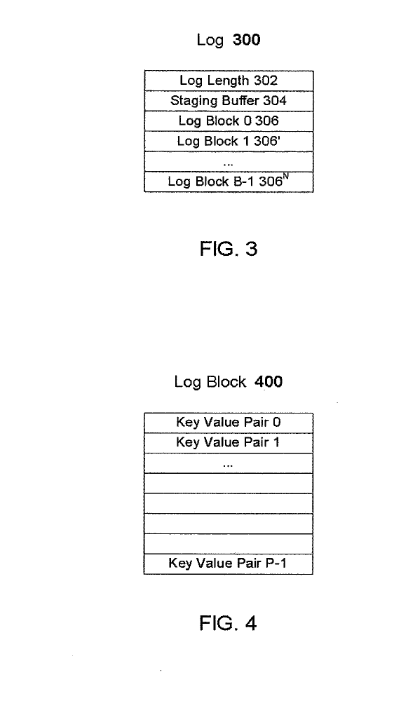

FIG. 3 shows the structure of one embodiment of a log 300. A Log Length field 302 maintains the number of key-value pairs that are stored in the log 300. In one embodiment of the invention, a processor that supports non-temporal store instructions is used along with a Staging Buffer 304. The Staging Buffer 304 is used to aggregate key-value records into a buffer that is the size of a cache line. Once the Staging Buffer 304 is full, non-temporal store instructions are used to copy the Staging Buffer 304 to the next unused Log Block 306. Each Log Block 306^{N} (labeled Log Block 0 through Log Block B-1) is also the size of a cache line. The use of non-temporal store instructions when performing this copy prevents cache lines from being replaced with data that is not likely to be needed again soon. Depending on the processor, the Staging Buffer 304 and Log Blocks 306^{N} may need to be aligned on particular address boundaries for improved performance.

FIG. 4 shows the structure of the Staging Buffer 304 and Log Blocks 306^{N} in another embodiment of the invention. As depicted, an integral number of key-value pairs are packed into consecutive addresses and the size of the structure is the size of a cache line. In still another embodiment, used on a processor without non-temporal store instructions, a Staging Buffer 304 is not used and each Log Block 306^{N} is sized to contain a single key-value pair.

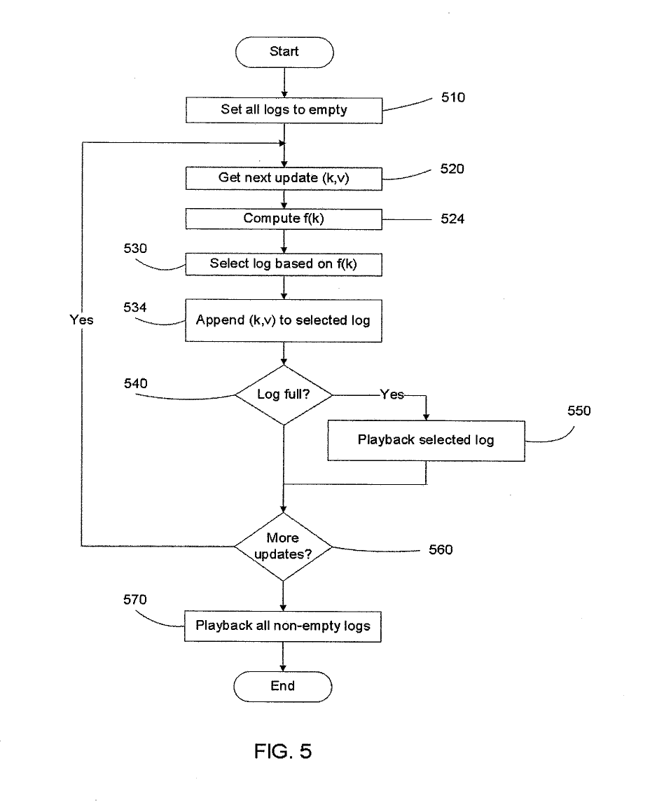

FIG. 5 presents a flowchart depicting one embodiment of the process of applying an input sequence of updates to a hash table. The sequence of updates can take the form of a list of key-value pairs or can, for example, be the result of applying a calculation.

First, the logs associated with the hash table are initialized to be empty (Step 510). Memory is allocated for the data structures (if not pre-allocated) and the Log Length field is set to zero for each log. The loop which processes the sequence of updates is now ready to begin; and one update is processed per iteration. The loop begins with retrieving the next key-value pair from the sequence of updates (Step 520). The next (k,v) pair can be retrieved from a table or by performing a calculation that is specific to the application using the embodied invention. The hash function, f(k), is then computed for key k (Step 524). The hash function returns the location that the key-value pair will be stored in the hash table, assuming the absence of collisions. This location may be an actual address in memory or, equivalently, an index into an array. Based on the value of the hash function, a log is selected (Step 530) and the (k,v) pairs are appended to the selected log (Step 534).

The process of selecting the log that corresponds to f(k) consists of identifying the band to which the hash function value belongs, and then looking up or calculating the log that corresponds to that band. In one embodiment of the invention, the processes of identifying the band and consequently the log that corresponds to (k,v) is performed as a single step for maximum performance. For example, suppose that f(k) returns a index into the hash table depicted in FIG. 2 and that the hash table has room for M entries as shown. Given that there are N bands, an integer that identifies the band can be computed by:

Band Index=f(k)/N

where the “/” operation is integer division. The Band Index may be used to index into an array of log structures and thereby select an appropriate log to use for storing the (k,v) pair.

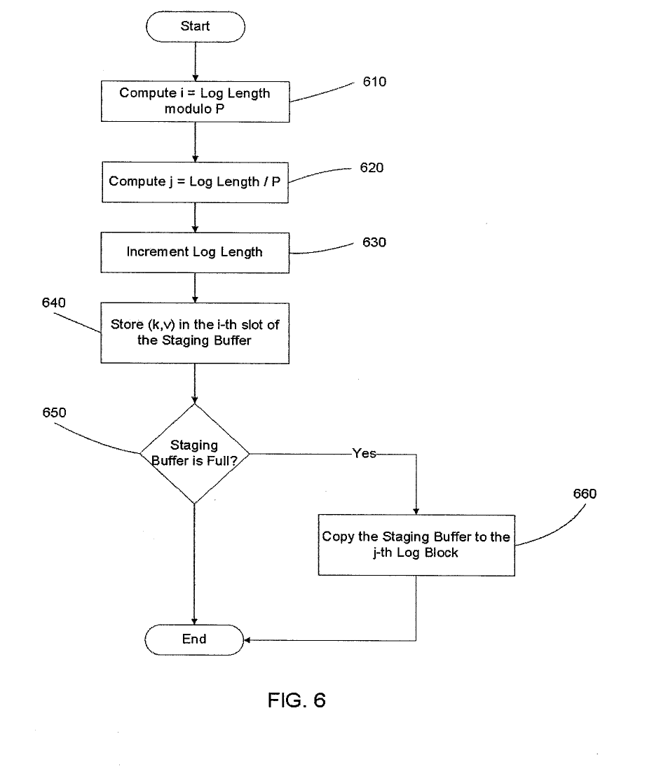

FIG. 6 presents a flowchart depicting one embodiment of the process of appending a (k,v) pair to a selected log in an embodiment of the invention that uses a Staging Buffer. The value P refers to the number of (k,v) pairs that can fit in a cache line. Indices i and j are first computed (Steps 610 and 620). In Step 620, the “/” operation is integer division. The Log Length is incremented (Step 630) and the (k,v) pair is copied to the i-th slot in the Staging Buffer. If the (k,v) pair took the last of the P slots in the Staging Buffer, then the Staging Buffer is flushed to the log (Step 660) by copying the Staging Buffer to the j-th Log Block in the Log. In one embodiment of the invention, the copy in Step 660 is performed in such as way as to minimize the replacement of cache lines by using non-temporal store instructions.

In another embodiment of the invention, neither a Staging Buffer nor non-temporal store instructions are used. Each Log Block is sized to contain a single Key-Value pair (i.e., parameter P=1) and the (k,v) pair is merely copied to the next available Log Block indexed by Log Length. Log Length is then incremented to reflect the addition of one more Key-Value pair.

With further reference to FIG. 5, after the (k,v) pair is appended to the appropriate log, the log may become full. Once a log is full, the (k,v) pairs that are stored in the log are played back (Step 550) in the order in which they were appended.

The process of appending (k,v) updates to the appropriate logs and playing back full logs continues until all the updates in the input sequence have been processed. When there are no more updates (Step 560), there will likely be unapplied updates still left in the logs. All logs are tested at this time and if not empty, are played back (Step 570). The updates will have now been applied to the hash table in a manner that improves cache utilization.

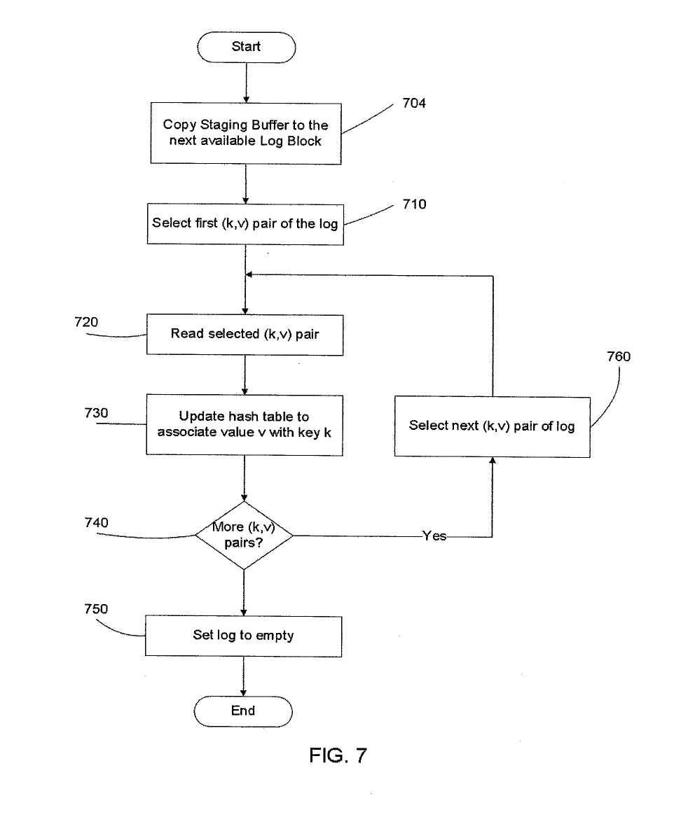

FIG. 7 is a flowchart depicting one embodiment of a method for log playback in accord with the present invention. The process of playing back a log is invoked in two cases: (1) when a log is full and (2) when there are no more (k,v) updates in the input sequence to append to any log. In the latter case, for those embodiments of the invention that use a Staging Buffer, the Staging Buffer may not be empty and the (k,v) pairs previously written to the Staging Buffer are copied to the next available Log Block (Step 704). Flushing the Staging Buffer allows playback to be performed entirely from the Log Blocks without treating the (k,v) pairs in the Staging Buffer as a special case. In embodiments of the invention that do not have a Staging Buffer, Step 704 is unnecessary.

Log playback consists of a loop which reads the next (k,v) pair from the Log Blocks, updates the hash table with the (k,v) pair, and repeats the loop until all of the (k,v) pairs in the Log Blocks have been applied to the hash table in the order in which they were appended to the log. Before entering the loop body, the first (k,v) pair stored in Log Block 0 is selected (Step 710). The loop consists of reading the selected (k,v) pair (Step 720) and then updating the hash table with the (k,v) pair (Step 730).

There are many ways to update the hash table. In the simplest case, using a linear hash table without collisions, an update consists of replacing the key-value pair at location f(k). Various methods of dealing with hash collisions are known to the prior art and may be used in connection with various embodiments of the invention. In one embodiment of the invention, hashing operates in a regime where the hash collision rate is low so that the band classification based on the value of f(k) will lead to the best cache utilization.

After updating the hash table with the selected (k,v) pair, the existence of more (k,v) pairs to process is determined (Step 740). In one embodiment of the invention, this consists of keeping a count of the number of (k,v) pairs that have been processed and comparing it with the value of Log Count. If there are more (k,v) pairs to process, the next (k,v) pair in the log is selected for the next iteration of the loop (Step 760). The next (k,v) pair is simply the next entry in the current Log Block, or the first entry of the next Log Block after all (k,v) pairs of the current Log Block have been processed. If there are no more (k,v) pairs in the log to process, the final step of log playback is to set the log to empty (Step 750), e.g., by setting the Log Count to zero.

### Exemplary Applications

Differential data compression techniques are widely used in document transmission systems to reduce cost. The lifecycle of a document often consists of discrete versions of that document. Whenever a new version of a document is to be transmitted, resources can be saved by using a data coding scheme where strings that are shared with a prior widely-known version of the document are represented by a code that is shorter than the represented string itself. Such an encoding scheme is often called a dictionary coder because the code is a shorthand representation of strings in a data dictionary known to the encoder and decoder. In the case of differential compression of a document that consists of discrete versions, a prior version of the document is a natural choice for the data dictionary.

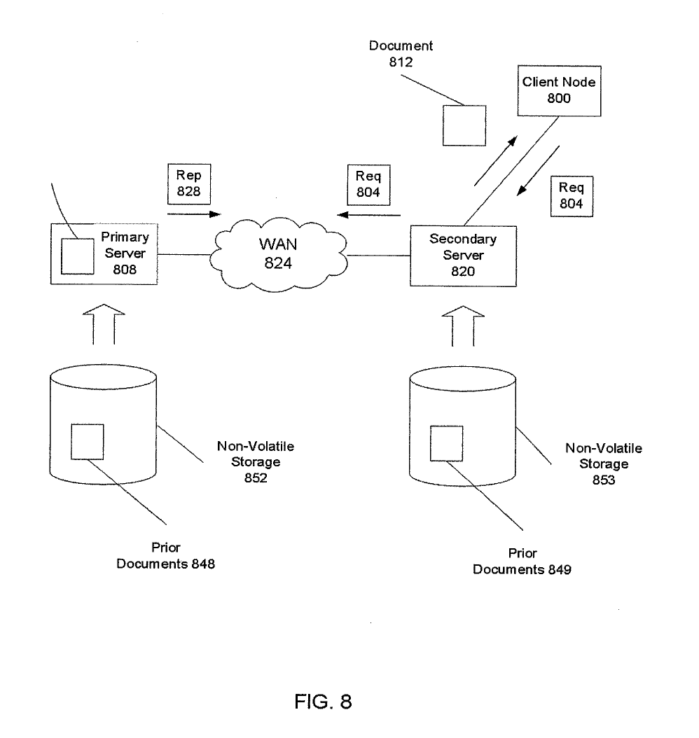

FIG. 8 shows an embodiment of the present invention suited for use in differential data compression applications to reduce the bandwidth requirements for document transfer over a wide area network (WAN) 824. The client node 800 sends a request 804 to the primary server 808 requesting a document 812. The request 804 may be encapsulated in a transport protocol such as HTTP, FTP, CIFS or the like. The request 804 is first received by the secondary server 820. The secondary server 820 in turn forwards the request 804 to the primary server 808 across the WAN 824. The secondary server 820 may inspect the request to determine which document is being requested of the primary server 808. In one embodiment, both the primary and secondary servers 808, 820 have an identical collection of prior documents 848, 849 that are kept on non-volatile storage 852, 853. Both servers 808, 820 retrieve a prior version of the requested document from non-volatile storage 852, 853 and use the prior version of the requested document as the data dictionary for dictionary coding. The primary server 808 responds to the request 804 with a reply 828 that contains the encoded document. Upon receiving the reply 828, the secondary server 820 decodes reply 828 using the data dictionary to reconstitute the original document 812. The document 812 is then sent to the client node 800, completing the transaction.

The process of encoding a document using a data dictionary consists of two distinct phases, the first of which is to create an index for quickly looking up strings in the data dictionary. For each byte offset into the data dictionary, a hash is constructed of the q-byte sequence that starts at the byte offset. The parameter q is a design parameter chosen to correspond to the minimum length of strings that the coder will match in the data dictionary. This process produces an association of the string hash to the byte offset into the data dictionary where a string with that hash is located. Such associations are generally denoted as key-value pairs, where in this case the string hash is the key and the location of the string in the data dictionary is the value. In the general case there can be multiple values associated with the same key, but some coders may be designed to store only one of the many values sharing a key to increase performance at the expense of compression. A data structure that is widely used by dictionary coders to store key-value pairs for the data dictionary is a hash table. Hash tables have the property that insert and lookup can be performed in constant time, in contrast to the O(log n) or slower time complexity of trees and lists.

Once the key-value pairs for the data dictionary are known and stored in the hash table, the second phase of document encoding can begin. Encoding consists of stepping through the document to be encoded, generating a hash of each q-byte string that needs to be transmitted (i.e. the key), looking up the locations within the data dictionary (i.e. the values) that share that key and finally checking the string or strings in the dictionary for a match. If the data dictionary contains a string that matches, a code referring to that string is transmitted instead of a literal copy of the string itself.

The data dictionary, hash table and the document to be compressed are usually kept in memory for the highest performance of the dictionary coder. A system that is designed to transmit new versions of any of a plurality of documents may only wish to maintain a persistent copy of the data dictionary for each document and create the hash table as needed. Such a system needs good performance in building hash tables over the range of document sizes (and consequently data dictionary sizes) that will be encountered. Unfortunately, CPU cost per byte to build a hash table can vary by orders of magnitude depending on the size of the hash table. Because of poor locality of memory reference, the process of building a hash table that is larger than the processor cache often runs at the slower speed of memory than the much faster speed of cache memory.

Accordingly, the methods and apparatus of the present invention, which are suited to the implementation of hash table operations having improved performance, are useful in document transmission applications utilizing differential data compression techniques as discussed above.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description but instead by the scope of the claims.

What is claimed is:

1. An apparatus for updating a hash table, the apparatus comprising:
a processor;
a fast memory; and
a system memory comprising:
a hash table, the hash table broken into bands, each band smaller in size than the size of the fast memory; and
a plurality of logs, each log associated with a hash table band and comprising updates to the hash table,
wherein the processor is configured to apply updates to the hash table as each log becomes sufficiently full.

2. The apparatus of claim 1 wherein the fast memory is a processor cache memory.

3. The apparatus of claim 1 wherein each update is a key-value pair (k,v).

4. The apparatus of claim 1 wherein the processor is configured to place each update in a log selected in part based on the value resulting from the application of a hash function to the key k.

5. A method of updating a hash table, wherein each update comprises a key-value pair (k,v), the method comprising:
initializing each of a plurality of logs to an empty state;
selecting one of the plurality of logs based on the value f(k) resulting from the application of a hash function f to the key k in an update;
appending the update to the log; and
playing back the log if the log has become sufficiently full.

6. The method of claim 5, wherein play back of a log comprises:
reading each update from the log;
modifying, for each read update, the hash table at the location f(k) resulting from the application of a hash function f to the key k in an update; and
setting the log to the empty state once all updates have been read.

7. The method of claim 6 further comprising playing back all of the logs.

8. The method of claim 6 wherein each update is read from the log in the order in which it had been appended to the log.

9. The method of claim 5, wherein selecting one of the plurality of logs comprises:
dividing a hash table into equally sized regions of the range of f(k), each region being sufficiently small so that modifications to the region can be performed solely in a fast memory; and
mapping each value of f(k) to an integer that can be used to select a log from the plurality of logs.

10. The method of claim 9 wherein the mapping comprises dividing f(k) by an appropriate constant or performing a bit shift by an appropriate constant.

11. The method of claim 5, wherein the method of appending the update to the log comprises:
appending the update to a staging buffer, the staging buffer being stored in a fast memory and being a multiple of a processor cache line in size; and
writing the staging buffer to the log when the staging buffer is sufficiently full.

12. The method of claim 11 wherein the writing of the staging buffer is performed using a store instruction that bypasses or otherwise limits the persistent modification of the fast memory.

13. The method of claim 6, wherein reading each update from the log comprises:
reading a plurality of updates from the log into a register file or a buffer in cached memory, the length of the read being a multiple of the processor cache line size.

14. The method of claim 13 wherein the reading of the plurality of updates is performed using a load instruction that bypasses or otherwise limits the persistent modification of the fast memory.
